(19) United States
(12) Patent Application Publication
(10) Pub. No.: US 2010/0106663 A1
(43) Pub. Date: Apr. 29, 2010

(54) SYSTEM AND METHOD FOR FACILITATING CHARITABLE DONATIONS AND GOALS

(76) Inventor: Hao Dunne Hoang, Santa Monica, CA (US)

Correspondence Address: Zarian Midgley & Johnson PLLC, University Plaza, 960 Broadway Ave., Suite 250, Boise, ID, 83706, US

(21) Appl. No.: 12/608,741

(22) Filed: Oct. 29, 2009

Related U.S. Application Data
(60) Provisional application No. 61/197,663, filed on Oct. 29, 2008.

(51) Int. Cl. G06Q 99/00

(52) U.S. Cl. 705/329

(57) ABSTRACT

A method and apparatus for a business process that permits an entity to post a charitable cause or other cause at a public organizational web site allowing the cause to be reviewed and ranked by the market place. A community of supports, including financial and other material supports, for example, is established to support each cause and facilitate the completion of its mission. Entities, such as vendors and service providers, for example, are tracked and reimbursed by the organization. The business process further provides for the tracking of payments and expenditures and provides reports to payers and organizations that champion, i.e., support, each posted cause.

### RELATED APPLICATIONS

This application is related to and claims priority from provisional application Ser. No. 61/197,663 filed Oct. 29, 2008, which is incorporated by reference as if fully set forth herein.

### BACKGROUND

The present application relates generally to a system for facilitating a charity or a business organization and, more specifically, to a host corporation that provides systems and methods for facilitating social networking which allows payers and users to select the best entity to pursue a given charitable cause or business objective.

Charitable giving has long been lauded as a desirable social objective. Present charitable donating systems typically include two parties—the donor or payer and the donee charity. Many charities use fundraising techniques such as auctions and telethons, for example, to increase donations and exposure to new donors. As many causes that are worthy of support exist, the nonprofit fundraising industry is extremely fragmented. The causes can range from religion to pet adoption with many variations in between. Furthermore, the charities supporting these causes range from the gigantic national charities to single individuals.

Many well-known charities such as the Red Cross, the Salvation Army, and The Cancer Society, for example, use their recognizable name to raise donations from major donors, such as corporations, foundations, and individuals. After deducting expenses, the remainder of the donations fund programs supporting causes mandated by the particular charity's charter. These charities appear, at times, to be impersonal and inflexible in their services and their responses to problems. Furthermore, these large charities will typically have high administrative and organizational costs.

Other types of nonprofit organizations such as Team-In-Training, AIDS Ride, the Avon Breast Cancer walkathon. For example, rely heavily on volunteers to raise donations from friends and families. Their causes are highly defined and visible. Donations are absorbed into the organization prior to distribution to their cause. Again, as described above, these types of nonprofit typically will have high event fees and administrative and organizational costs.

Typically, individuals or smaller nonprofit organizations that raise donations for their own causes have no name recognition and the potential to raise large amounts of funding is limited. Their limited budget, manpower and resources make it difficult to promote their causes. Since they typically rely on a very few contributors for their contributions, these donors often develop donor fatigue. Hence, fundraising becomes a constant process which absorbs more and more of their time and resources, commodities that individuals and small nonprofit organizations can ill afford to spend. Any time remaining is used to fulfill the mission of the nonprofit organization; this leaves them vulnerable to exhaustion and burn-out within a short amount of time.

On the other hand, while present methods of donating allow donors to donate for causes they support, these methods typically do not allow the donors to specifically target their donations to a cause they desire to support. The traditional donor also cannot track the use of their donation to monitor precisely how it is spent. For example, a common concern is that donations do not make their way to the intended recipients, either because the resources are diverted to other purposes or because too large of a percentage goes to administrative costs associated with the charitable organization. It is especially difficult for the donor to make small donations for specifically targeted purposes of the donor's choosing, and to monitor and track the use of the donations.

More recently, charitable organizations have turned to the Internet to increase their exposure to potential donors and to make it easier for donors to donate. While some charitable organizations, such as the Red Cross or the United Way, for example, provide websites on the Internet for donors to use, typically the donor is allowed to choose only between causes allowed by the charitable organization's charter. Other organizations, either for profit or nonprofit, not associated with any particular charitable organization or organizations provide aggregated websites which allow donors to choose between a number of charitable organizations and causes to receive their donations. However, typically the way charitable organizations and causes are selected for presentation on the aggregated website is a closed process. A charitable organization or other entity submits a proposal for a cause to the aggregated website. The aggregated website organization then reviews and evaluates the proposal in-house. They determine if the proposal meets their criteria and, at some point, typically will interview the organization submitting the proposal. If the proposal is accepted by the aggregated website organization, then media materials and other information are collected and the proposal is added to the aggregated website and made available to the donor. However, this provides no rating or ranking for the organization submitting the proposal or for the proposal itself. Further, no information is provided about the decision making process itself used by the aggregated website organization.

### SUMMARY

The present application discloses a method that uses the Internet to facilitate charitable donating and to allow one or more entities to post charitable causes and other causes, such as business objectives, for example, at an organization aggregated website. The use of social networking allows other entities, individuals, small companies, small nonprofit organizations, small for-profit businesses and startups, for example, to evaluate and to provide comments, recommendations and other information to support the posted charitable causes and other causes. Other entities also provide a ranking for each posted cause indicating the social value of the charitable cause or other causes. Thus, each posted cause will be market-sorted and market-approved by other entities. A community of supports, including financial and other material supports, for example, is established to support each cause and facilitate the completion of its mission. Entities, such as vendors and service providers, for example, are tracked and reimbursed by the organization. The method further provides for the tracking of payments, such as charitable donations, for example, and expenditures and provides reports to payers, such as charitable payers, for example, and charitable organizations that champion, i.e., support, each posted cause.

### BRIEF DESCRIPTION OF THE DRAWINGS

The following figures, in which like numerals indicate elements, form part of the present specification and are included to further demonstrate certain aspects of the present disclosure. The disclosure may be better understood by reference to one or more of these figures in combination with the detailed written description of specific embodiments presented herein.

FIG. 1 is a block diagram illustrating an embodiment of a system for receiving payments, posting charitable causes or other causes and the fulfillment of the causes;

FIG. 2 is a flow chart illustrating the processes implemented by the system of FIG. 1;

FIG. 3 is a flow chart illustrating an embodiment of a registration process used for the system of FIG. 1;

FIG. 4 is a flow chart illustrating an embodiment of a main page of FIG. 2;

FIG. 5 is a flow chart illustrating an embodiment of a content posting process;

FIG. 6 is a flow chart illustrating an example embodiment of a social networking process of FIG. 2;

FIG. 7 is a flow chart illustrating an example embodiment of a transaction process illustrating payment for goods and services; and

FIG. 8 is a flow chart illustrating an embodiment of an accounting process of FIG. 2.

These and other embodiments of the present application will be discussed more fully in the description. The features, functions, and advantages can be achieved independently in various embodiments of the claimed invention, or may be combined in yet other embodiments.

### DETAILED DESCRIPTION

One or more illustrative embodiments are described below. Not all features of an actual implementation are necessarily described or shown for the sake of clarity.

The present application discloses a method that uses the Internet to facilitate payments, such as charitable donations, for example, and to allow one or more entities to post charitable causes or other causes at an organization aggregated website. The use of social networking allows other entities, individuals, small companies, and small nonprofit organizations, for example, to evaluate and to provide comments, recommendations and other information to support the posted causes. Other entities also provide a ranking for each posted cause indicating the social value of the cause. Thus, each posted cause will be market-sorted and market-approved by other entities. A community of supports, including financial and other material supports, for example, is established to support each cause and facilitate the completion of its mission. Entities, such as vendors and service providers, for example, are tracked and reimbursed by the organization. The method further provides for the tracking of payments and donations and expenditures and provides reports to donors or payers and organizations that champion, i.e., support, each posted cause.

The system and method of the present disclosure contemplates the involvement of four or more parties, including the system provider. As used herein, the following terms will be ascribed the following meanings:

1. “Host” shall mean the entity, individual, company, nonprofit corporation, or for-profit corporation, any other organization, or any combination thereof, which is the system provider who hosts a public web site and provides various services, such as accounting, disbursement of funds, various transactional services and social networking tools, for example, as described in greater detail herein. For example, the Host may be a nonprofit corporation providing services to payers or donors to facilitate the use and distribution of payments, such as charitable donations, for example. Alternately, the Host may be a for-profit corporation or a hybrid for-profit/nonprofit corporation which is compensated for its services.

2. “Payer” shall mean the person, company, nonprofit corporation, for-profit corporation, or any other organization, or any combination thereof, which makes the payment or charitable donation to the Host for support of one or more specific charitable causes or other causes. Typically, at the time of the making a payment, a Payer will select a Champion, who is able to designate a Charity or other entity for receipt of the benefits of the payments. A Payer may also post a charitable cause or other cause of their own and select a willing Champion to take up the cause and carry it to a successful conclusion.

3. “Champion” shall mean the person, company, nonprofit corporation, or for-profit organization, or any other organization, or any combination thereof, which supports one or more specific charitable causes or other causes and who manages the activities in support of its cause or causes and directs the disbursement of the payments by the Host.

4. “Charity” shall mean the person, company, nonprofit corporation, for-profit corporation, or any other organization, or any combinations thereof, which carries out one or more specific causes, such as a charitable cause, for example, and finally receives the benefits of the payments. A Charity may be a for-profit corporation or a nonprofit organization and enjoy tax-exempt status, for example.

5. “Vendor” shall mean a person, company, nonprofit corporation, for-profit organization, or any other organization, or any combination thereof, which provides goods or services to a Charity. Such goods and services may include, for example, fundraising events and charitable auctions.

6. “User” shall mean any person, company, nonprofit corporation, for-profit organization, or any other organization, or any combination thereof, who has registered with the public web site as a User and who takes part in the social networking process to provide ranking, rating, recommendations, suggestions and other information pertinent to a particular charitable cause or other cause for completion of the cause mission. Users may also include guests who have not registered with the public web site as a User.

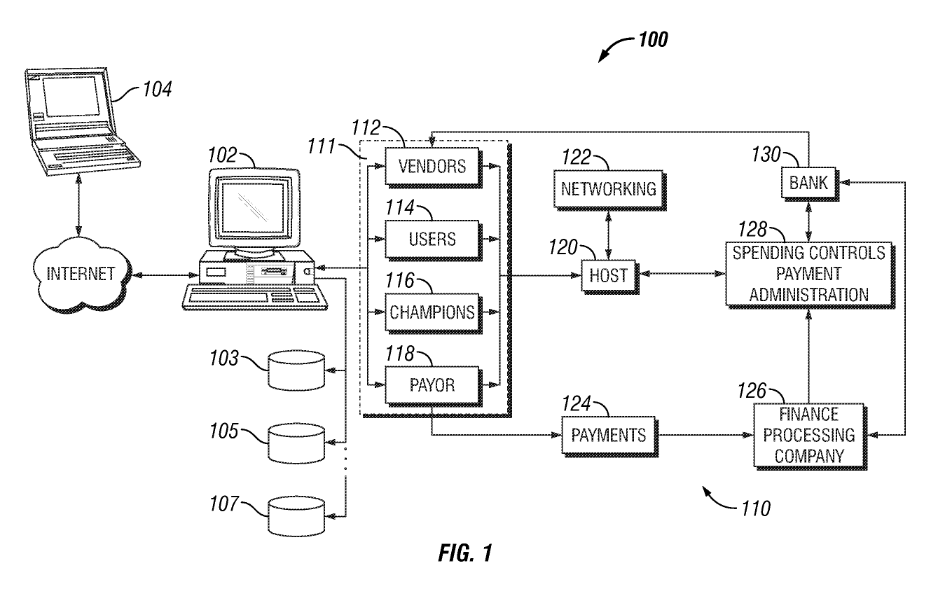

Referring now to FIG. 1, a system 100 implementing the system and methods of the present disclosure is shown. Server 102 is configured by software 110 to host an online organization 120, the “Host,” that receives payments, charitable donations, for example, and provides the administration of such payments or donations to support specific charitable causes or other causes. While the present disclosure is directed primarily to the receipt and administration of payments or donations in support of charitable causes, it should be noted that other causes such as small business, environmental or public safety, for example, causes may also be supported and administrated by the system 100 and Host 120. The Host 120 provides a public web site 111 as well as various services, such as accounting, disbursement of funds, various transactional services and social networking tools, for example. Payers, Champions, Vendors and other Users connect to the server 102 and access website 111 via a terminal 104, for example. Terminal 104 may be a desktop or laptop computer, or any other device with wired or wireless access to the internet. Alternatively, server 102 could be accessed by telephone or other suitable means. In this case, voice menus and commands would be used to navigate through the site and make transactions. The server 102 is in communication with one or more storage devices 103, 105, 107 for storing various databases related to charitable causes, or other causes, payments, Charities, and expenditures and other transactions related thereto, for example.

In one embodiment, the Host 120, provides a public website 111 that includes one or more main pages 112, 114, 116, 118, each main page designed to facilitate a specific class of user. A particular user, a Payer, for example, will access and log in on the Payer main page 118. From the Payer main page 118, a Payer may make payments 124 through a finance processing company 126 for deposit in an appropriate account through a bank 130 or other financial institution. When a Payer makes a donation 124, the Payer also designates one or more causes, such as a charitable cause, for example, to receive the benefit of the donation. When the Payer designates a charitable cause, the Payer is actually designating a Champion that supports the designated charitable cause or other cause. The payments or donations 124 may be money, materials or services, for example. Cash payments or donations, for example, may be made by check or credit card directly or by utilizing one of various available commercial services such as PayPal, for example. The finance processing company 126 performs most or all financial functions for the Host 120 such as grant distributions, merchandizing transactions or other financial transactions. It also generates financial reports for Payers to track the financial spending by the Champions. It also verifies the identity of the Champions, Vendors and merchants for grant payments. The finance processing company 126 may be a part of the Host, or it could be a separate company such as a bank or other suitable company offering the appropriate services.

The Host provides a social networking process 122 to that allows Champions to post information, referred to as “content,” describing or otherwise related to the cause or causes a particular Champion is supporting. Such content may include may include web postings, comments, updates, photos, descriptive text, images, schedules and budgets, for example. A Champion may post content related to a charitable cause or other causes using socially accepted and readily available networking tools and techniques such as email, blogs, tags, twitter, YouTube, mobile messaging, podcasts and other readily available techniques. Social networking exposes the user-created content to the marketplace allowing Champions to promote and market their charitable causes or other causes and to receive feedback from Users, Payers and other supporters of their charitable causes or other causes. The social networking process creates a dialogue between Users, Payers and supporters, and the Champions related to the progress of their causes. This social interaction promotes the success of a Champion's cause; especially when the Payers, Users and other supporters believe that their support and input contribute to the success of their Champion's cause or causes. The Payers, Users and other supporters can track the progress of the cause goal or mission and the related financial transactions using the same crowd sourcing tools 122. Additionally, the social networking process is transparent and the Champions are held accountable for using their payments received, charitable funds, for example, and in-kind donations responsibly and efficiently.

A cause, rather than a Champion, may also become the focus of the social networking process 122. For example, a Payer may post a charitable cause or other cause and related content to the Payer main page; using the same crowd sourcing tools available to a Champion, the Payer created cause and related content is exposed to the marketplace allowing the Payer to promote and market the cause. Champions, Users and other supporters can then provide feedback and recommendations assisting the Payer to choose a Champion or team to lead the charitable cause or other cause and carry it through to a successful conclusion.

The host 120 provides various administration services 128 such as spending control and monitoring services, payment and other financial transactions, and reporting, for example. For example, the payment service processes payments, fees, financial transactions, verifying identity and grant distribution. Payments and other monies or assets received, and other financial transactions are posted in appropriate Host accounts held in a bank 130 or other suitable financial institution. A Champion via the Champions main page 116 and the Host 120 can use a payment tool to process grant payments to Vendors and merchants; when such a request is approved, the bank 130 completes payment to the appropriate Vendor via payment instructions posted on the Vendor's main page 112.

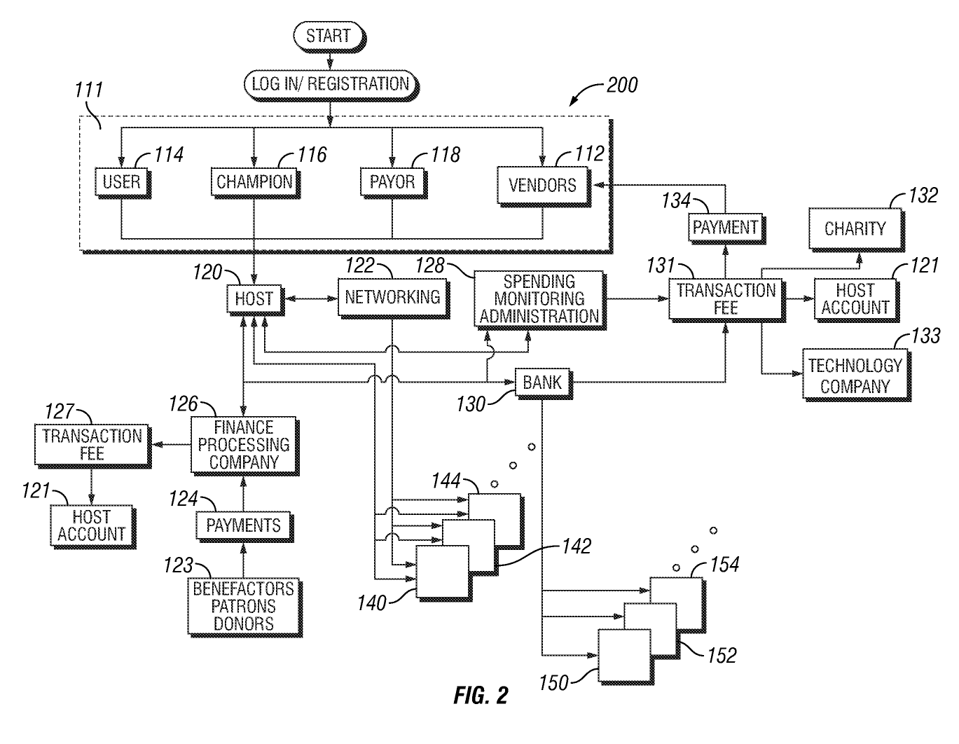

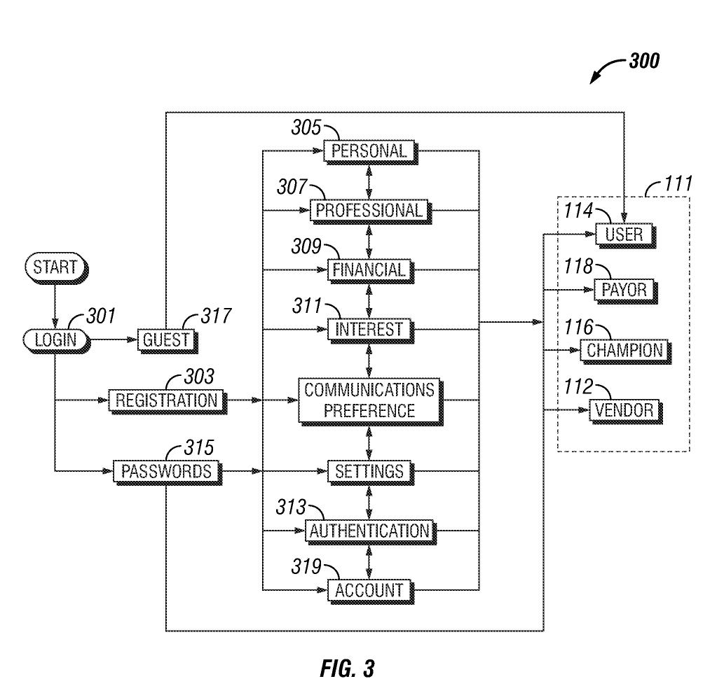

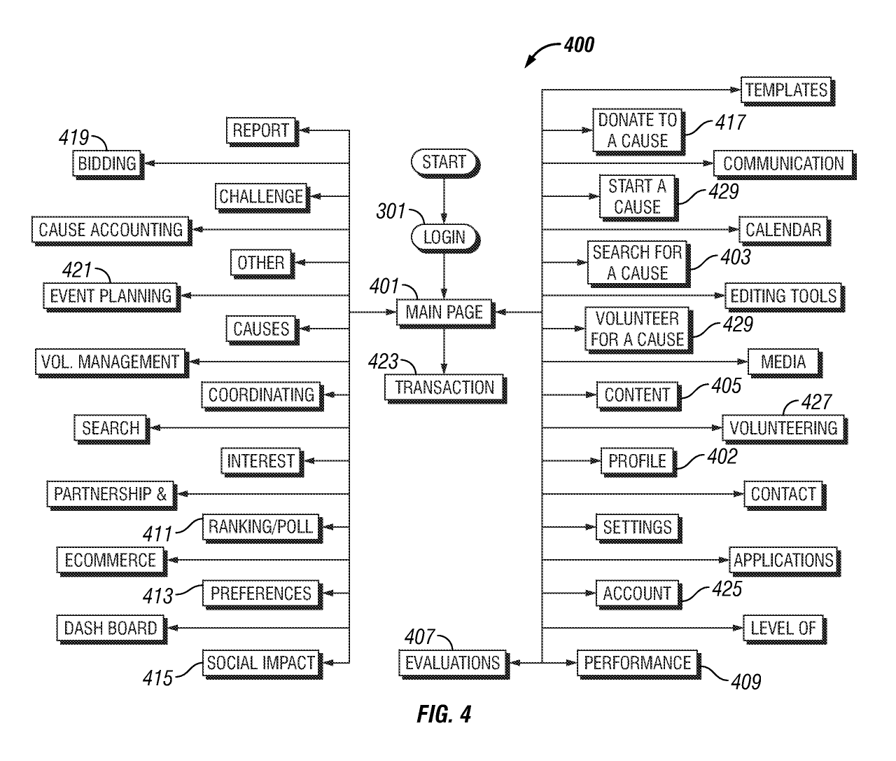

Referring now also to FIG. 2, a flow chart 200 illustrating some of the processes and activities implemented by the system of FIG. 1 is shown. Initially, a user must log in to the public website 111 and register in a desired class of user, User, Payer, Champion or Vendor, for example, as described in more detail below with reference to FIG. 3. Once registered, a user, a Payer, for example, can log in to the Payer main page 118. Each registered user will have a main page 112, 114, 116, 118, which is customized in accordance with information provided during the registration process. A user's main page, a Payer main page 118, for example, allows the Payer access to a number of different processes and activities. From the Payer main page 118, the Payer can make a payment, a charitable donation, for example, post a charitable cause or other cause, choose an existing cause or post content or related to a posted cause, for example, as explained in greater detail below with reference to FIG. 4. An entity may also initiate the social networking process 122 from its main page. Each cause is assigned an account or file 140, 142, 144, where all content, feedback and other information input by any user of the website, Champion, Payer or User, for example or resulting from the social networking process 122, related to that particular charitable cause is stored. Each cause account 140, 142, 144, includes the identities of its Champion and Charities 132 that support that cause. The Host 120 can be also accessed from a main page to initiate a transaction or other process. For example, a Champion via the Champions main page 116 can access the Host 120 to use a payment tool to process grant payments to Vendors and merchants. Once the payment is verified by the administration process 128, the bank 130 is directed to withdraw funds from the appropriate account and make the payment 134 to the Vendor in accordance with instructions posted at that Vendor's main page 112. A transaction fee 131 is charged for each financial transaction, including a payment, such as donation, for example, and deposited in the Host account 121 to cover administrative costs and expenses of the Host. In some cases, a direct disbursement or grant may be made directly to the Charity 132, for example, a non-profit corporation or other organization which has tax-exempt status. In other cases a fee 131 may be paid to a technology company 133. A technology company 133 is similar to a Vendor, but it primarily offers services or goods to the Host 120. For example, the technology is able to access private markets to raise money for the development and or build out of new technologies.

A charitable donation 124 may be made by a Payer from the Payer main page 118 as described above with reference to FIG. 1. Payments 124 may also be made from any of the Vendor, User or Champion main pages 112, 114 or 116, respectively, in the same manner as that described for payments made from the Payer main page 118. Payments may be made by any interested individual or other entity by logging on to the public website 111 as a guest, via the User main page 114, and following the process outlined above. Payments 124 may also be made directly at block 123 by any Payer in the form of cash, check, by credit or debit card, use of a financial service company or pledges for cash, materials or service, for example. As described above, when a payment, such as a charitable donation, for example, is made, a charitable cause or causes to be benefited by the donation is also identified by the Payer. The payments 124 are processed by the finance processing company 126 and passed on to the bank 130 for deposit in one or more accounts 150, 152, 154 created for the identified charitable cause or other cause associated with the charitable donation. A transaction fee 131 is charged for each payment 124 received and is deposited in the Host account 121 to cover administrative costs and expenses of the Host 120. As discussed above, a new charitable cause or other cause not previously posted at the public website 111 may be posted at the time a payment 124 is made. Once processed, the bank 130 deposits payments associated with the newly posted charitable cause or other cause are deposited in holding newly created account 150, 152, 154 and the process of selecting a Champion for the cause is initiated. When a Champion to support the newly posted cause is selected and identified, the new account 150, 152, 154 created for the newly posted cause is linked to the selected Champion.

Referring now also to FIG. 3, a flow chart 300 illustrating the login and registration processes is shown. A Vendor, a User, a Champion or a Payer accesses their respective main pages 112, 114, 116 or 118 via the login process 301. At its initial login to the public website 111, a user, individual, company, nonprofit corporation, for-profit corporation, or other organization, for example, must first complete a registration process 303 wherein it identifies, and registers, itself as a Vendor, a User, a Champion or a Payer which will associate it with a respective main page 112, 114, 116 or 118. During the registration process 303, the registering user is requested to provide including, for example, personal 305, professional 307, financial 309, interest 311 and authentication 313 information, for example, which is used for customizing a specific main page to reflect the user's profile, a Payer main page 118 for a user registering as a Payer, for example. Of course, not all of this information is required to be entered at registration; additional information and updates can be added each time a user logs in. However, during the registration process 303, sufficient information must be provided to set up user names and passwords 315, and to authenticate a user when that user logs in. At subsequent logins, a user is then required to use their user name and password to log in and can proceed directly to their main page, Payer main page 118 for a Payer, for example. Any user can login as a guest 317 without proceeding through the registration process 303 or being required to have a user name and password 315. At login, a guest 317 proceeds directly to the public website 11 and will be logged in to a generic Users main page 114.

As described above, at login 301, both during the registration process 303 and subsequent logins, a user has the opportunity to provide and update information to build a profile which reflected on the user's personal main page, Payer main page 118 for a Payer, for example. Of course, the information entered for the main page will vary depending on whether a user has registered as a User, Payer, Champion or Vendor. For a Payer, their custom or personal Payer main page 118, under the interest file 311, will reflect the charitable cause or other cause or causes that the Payer is supporting, for example. The Payer may also post a new previously not posted cause or causes that the Payer will support with payments. Similarly, for a Champion, the information entered under the interest file 311 may concern what cause or causes that Champion is supporting or will support. A Vendor, under the personal file 305 and professional file 307, will post information related to the Vendor's business, goods, materials and services offered, experience, pricing and schedules, for example. A Vendor will also set up a business account 319 which may include instructions for payment and outstanding statements, for example. A Vendor's main page 112 may also describe which goods or services that that Vendor is willing to donate to particular causes, or, perhaps, a Vendor will present bids for specific goods or services, for example.

Referring now also to FIG. 4, a flow chart 400 illustrating an embodiment of a main page of FIG. 2 is shown. As discussed above with reference to FIGS. 2 and 3, a user's personal main page 401, a Payer main page 118, for example, is customized for a particular user profile in accordance with information entered by the user during the login and registration processes. The personal main page profile file 402 is initially populated with information entered by the user during the registration process 303. While logged in to its personal main page 401, a user may add to or update its main page profile file 402. All functions and transactions provided by the Host 120 are performed or requested by a user, a Champion, for example, from the user's personal main page, the Champion main page 116, for example. A user logs in to its personal main page 401 via the login process 301. Once a user's personal main page 401 has been accessed, the user may choose from a number of function, activity and transaction modules to execute or participate in. For example, a Payer at its Payer main page 118 may desire to make a payment to a charitable cause or other cause or causes. First, the Payer can access the search module 403 to search for a cause or causes that have been previously posted. Each posted cause will be linked to a content file 405 associated with that cause that provides a description of and other information related to the cause. Each previously posted cause will include the identity of a Champion that supports the cause and will also be linked to a number of files such as an evaluations file 407 and a performance file 409, for example, which provide information and reports evaluating the Champion and the Champion's performance with respect to the particular cause or causes. Each previously posted cause will also be linked to a number of files, such as the ranking/polling file 411, a preferences file 413, and a social impact file 415 which provide information collected during the social networking process 122 thus allowing the potential Payer to evaluate the desirability of supporting a particular cause or causes. Once the Payer has selected a particular cause or causes to support with a payment, the Payer accesses module 417 to make the payment.

Any user of the system 100 may also post a new cause or causes on the public website 111 that has not been previously posted. A new cause or causes is posted from a user's personal main page, a Payer from its personal Payer main page 116, for example. In the case of a Guest user, the Guest may post a new cause or causes from the generic Users main page 114. A user, a Payer for example, accesses module 429 from the main page 401 to post a new cause or causes.

Each main page, Vendor main page 112, User main page 114, Champion main page 116 and Payer main page 118, will not necessarily allow access to all of the modules shown in FIG. 4. While several of the modules shown in FIG. 4 will be common to all main pages 401, the various modules available to a Payer at its personal Payer main page 118 may not necessarily be the identical modules available to a Vendor at its personal Vendor main page 112. For example, the bidding module 419 is available to a Vendor main page 112, but will not necessarily be accessible from a Payer main page 118. The bidding module 419 allows a Vendor to place bids for goods and services requested by a Champion. Similarly, the event planning module 421 is available to a Champion main page 116, but will not necessarily be accessible from a Payer main page 118. The event planning module 421 is used by a Champion to plan and execute various events, such as a fund raising event, for example, in support of the cause or causes it is supporting. The information stored in most of the file modules, such as the content file 405 or the social impact file 415 is related to posted causes and is accessible by all users of the public website 111. However, certain file modules and the information contained therein, such as a Vendor's bank account built in the account file 425 on a Vendor's personal main page 112, are accessible only by the registered owner of the main page and the Host 120 when executing transactions requiring access to those certain file modules.

A user, such as a User at its personal User main page 114, for example, may access certain modules to join in activities, such as generally volunteering at module 427 to provide support for any cause or causes that may need such assistance, or may volunteer to assist in support of a particular cause or causes at module 429. Any user may initiate or request a transaction 423 with or from the Host 120 from the user's personal main page. For example, as described above with reference to FIG. 2, a Champion may request a payment transaction from its Champion main page 116 directing the Host 120 to affect payment to a Vendor for goods or services in support of a cause or causes.

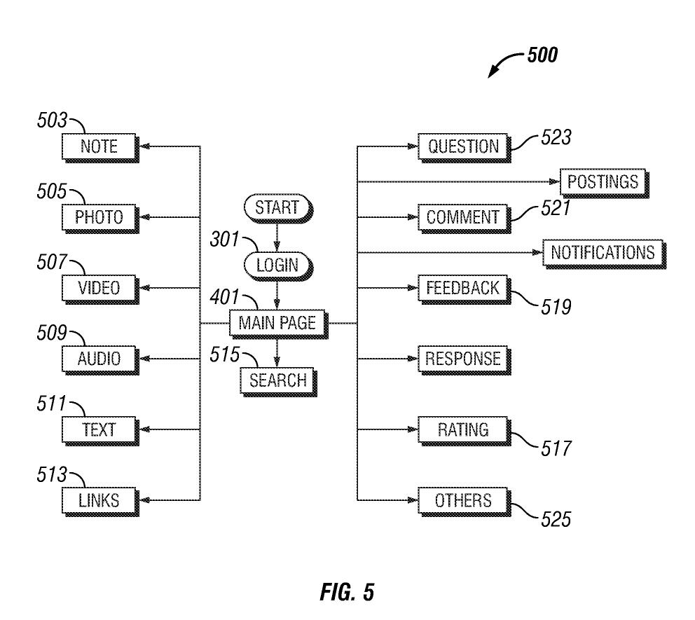

Referring now also to FIG. 5, a flow chart illustrating an example embodiment of a content posting process is shown. As discussed above with reference to FIG. 4, a user, a Payer for example, can post a new, previously not posted cause or causes at module 429. When a new cause is posted, a content file 405 linked to the newly posted cause is also opened. At the time of posting, the user posting the new cause will provide information related to the cause to the linked content file 405 from the user's main page 401, as shown in FIG. 4. This information can be descriptive information in the form of newspaper or magazine articles or other notes 503, photographs 405, video 507 or audio 509 clips, descriptive text 511 and/or links 513 to other information, such as blogs, for example, related to the newly posted cause. Other information such as information promoting the merits of the newly posted cause, for example, can be filed with the content file 405 at the time of posting. Subsequently, other users of the system 100, a User from its personal User main page 114, for example, can add or update the content file 405 for one or more posted causes. A user first accesses a search module 515 to find a particular cause or causes that it desires comment on or update existing information related to the cause or causes. When the user has selected a desired cause, the user is linked to that cause content file 405 as well as other files, such as a rating file 517, a feedback file 519, a comment file 521 or a question file 523, for example. The user can then enter its comments, updates or other information in the appropriate file, and that new information will now be available to other users. The feedback and comments related to a particular cause will vary depending on what class of user is providing the feedback and comments. For example, a Vendor, from its personal Vendor main page 112, can use the comment file 521 or the others file 525 to advertise and market their products and services various cause Champions. Other system users may then feedback commenting on and ranking the advertised products and services.

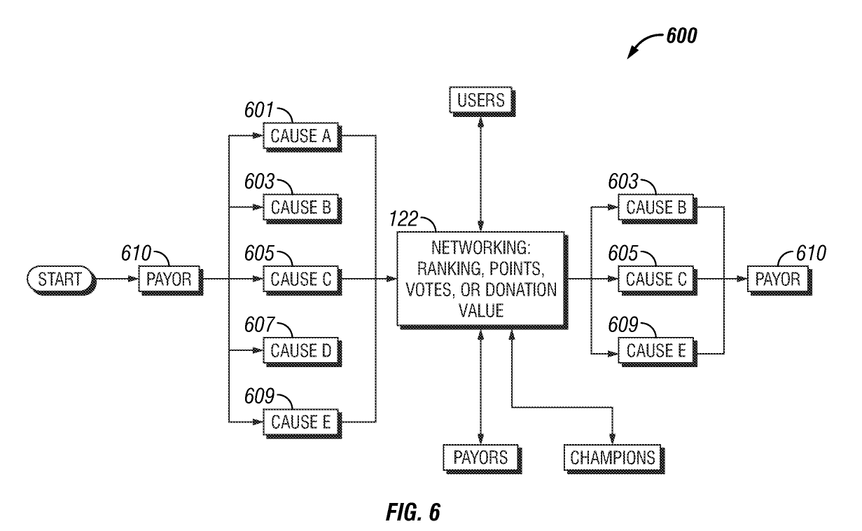

Referring now also to FIG. 6, a flow chart illustrating an example embodiment of a social networking process 122 of FIG. 2 is shown. The social networking process is an important part of the payment, such as a charitable donation, for example, process and contributes greatly to the successful pursuit and completion of a cause or causes. Various aspects of the social networking process have been discussed above with reference to FIGS. 1, 2, 4 and 5. For example, the discussions with respect to FIGS. 4 and 5 describing the process by which any user of the public website can comment on, update and provide feedback and ranking for a particular cause are parts of the social networking process discussed in the present application. One aspect of the social networking process is referred to as a “cause challenge” wherein the relative social importance of and the desirability of pursuing a particular cause or causes over another cause or causes is determined. Any user of the system, a Payer, a Champion or a User, for example, may challenge a cause or causes. As shown in FIG. 6, a Payer 610 may challenge one or more causes. To initiate a challenge, the Payer 610 will select one or more causes, cause A 601, cause B 603, cause C 605, cause D 607 and cause E 609, for example. The Payer 610 will then access the social networking process 122 via the Host 120. Then the users of the system, Users, Champions, and Payers, for example, from their respective personal main pages 114, 116, 118 will be asked to review and provide feedback concerning each of the selected causes. Guests may also participate in the challenge process by logging onto the generic Users main page 114. The feedback obtained in the process will include ranking and social impact of the selected causes 601, 603, 605, 607, 609 with respect to one another and is used by the social networking process 122 to derive a relative donation value or ranking of the selected causes with respect to each other. As shown in FIG. 6, at the conclusion of the cause challenge process, only three, cause B 603, cause C 605 and cause E 609, of the five causes selected by the Payer 610 survive the challenge process. The Payer 610 may then select one or more of the causes 603, 605, 609 to designate to receive the benefit of payments provided by the Payer 610.

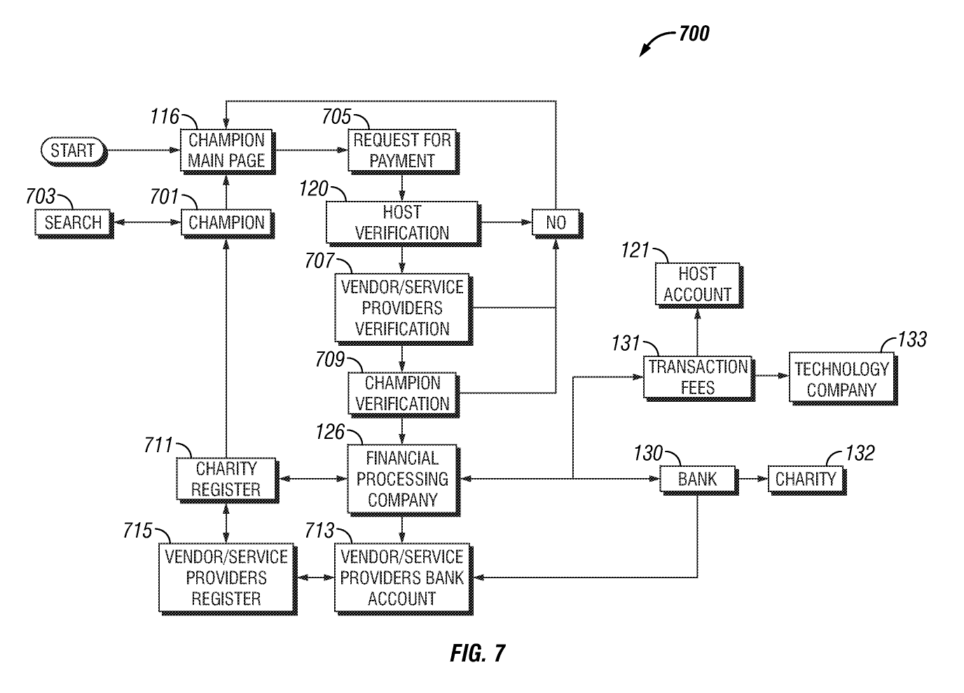

Referring now also to FIG. 7, a flow chart illustrating an example embodiment of a transaction process illustrating payment for goods and services is shown. As discussed above, the Champion 701 supports one or more specific causes identified by the Payer. In its role as a Champion, the Champion 701 performs most of the functions and activities, such as fund raising events, promotion and ordering goods and services, necessary for the mission of a cause to be successfully met. In order to make payment for goods and services or to make a direct distribution of funds, the Champion 701 may first search 703 for statements or invoices indicating that a payment is due. The Champion 701 then submits a request for payment 705 from its Champion main page 116 to the Host 120 for verification. The Host 120 submits the request to the Vendor for verification 707 and back to the Champion for final verification 709. If any of the verification processes, 120, 707 or 709 fail, then the request is returned to the Champion at its main page 116 for resubmittal. If the verification process 120, 707, 709 is successful, the request for payment is forwarded to the financial processing company 126 for handling and payment. The financial processing company 126 performs a number of actions to facilitate accounting requirements such as making an entry on the Charity register 711 and retrieving payment instructions from the Vendor bank account 713. Instructions to make the payment and a transaction fee are forwarded to the bank 130. The bank 130 forwards the payment to the Vendor bank account 713 and deposits the transaction fee 131 in the Host account 121. If the request is for a direct payment or distribution to the Charity, the bank 130 forwards the payment to the designated Charity 132. To complete the transaction, an entry is made in the Vendor register 715 and the Charity register 711 that the payment has been completed.

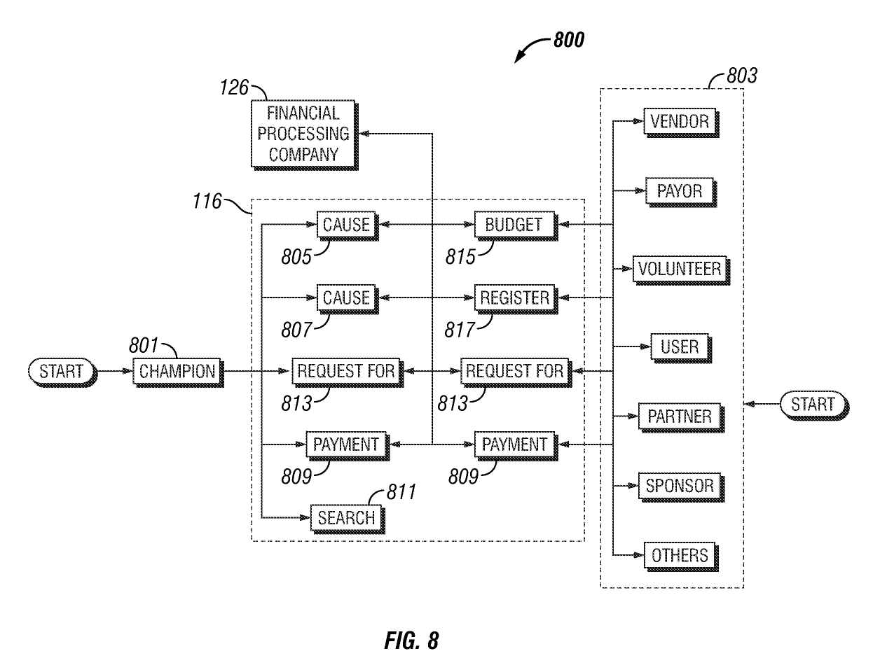

Referring now also to FIG. 8, a flow chart illustrating an embodiment of an accounting process of FIG. 2 is shown. As discussed above with reference to FIGS. 1, 2 and 7, the financial processing company 126 processes payments, transaction and other fees, financial transactions, verification and donation or grant distributions, for example. All information related to financial transactions, payments, donation or grant distribution, for example, is posted on the account pages 805, 807 of the appropriate Champion main page 116 and is typically indexed by the cause or causes affected by the financial transactions. Alternatively, financial and account information can be posted in accounts identified by the particular cause or causes benefited by the transactions with a link to the appropriate Champion main page. Information related to specific payments of the status of a payment request may also be posted in a separate file 809, preferably indexed by cause. A Champion 801 can access financial and accounting information related to the causes that it supports on its Champion main page 116. As discussed above, this information will be posted on account pages or files 805, 807, 809 accessible from the Champion main page 116. The Champion 801 may also search for related financial and accounting information posted on or linked to its Champion main page 116 using search module 811. A Champion may also request 813 specific financial or accounting information directly from the financial processing company 126. A Champion's Payers, supporters and other interested parties 803 may also access their Champion's main page 116 to track the financial transactions, including financial reports generated from these financial transactions, of their Champion. For example, Payers, supporters and other interested parties 803 may review the budget 815 for a particular cause 805, the register 817 where all transactions are posted for a particular cause 807 or may review payments 809 made or requested by the Champion 801. Similarly, a Payer, supporter or other interested party 803 may request 813 specific financial or accounting information related to their Champion's cause or causes, or search for related financial and accounting information posted on or linked to their Champion's main page 116 using search module 811.

Although the present disclosure has been described in terms of certain embodiments, other embodiments that are apparent to those of ordinary skill in the art, including embodiments which do not provide all of the features and advantages set forth herein, are also within the scope of this disclosure. Accordingly, the scope of the present disclosure is defined by the claims that follow.

What is claimed is:

1. A method of receiving and utilizing online payments, comprising:
establishing a web site comprising a database of one or more causes that may be selected by a payer, and a database of one or more entities, each entity associated with one or more of the causes;
receiving a payment from a payer, the payer selecting one or more of the causes to receive the benefit of the payment;
forwarding the payment to a host, the host holding the payment in an account associated with the selected cause; and
the host disbursing a portion or all of the payment as directed by the entity associated with the selected cause;
wherein a portion of or all of the payment being disbursed to compensate providers for goods or services procured by the entity associated with the selected cause for carrying out a mission of the cause.

2. The method of claim 1, further comprising the step of providing accounting information associated with the selected cause allowing at least the payer to track the disbursement of the payment.

3. The method of claim 1, wherein a portion of or all of the payment may be disbursed to a charity to carry out the mission of the cause.

4. The method of claim 1, further comprising the steps of:
posting the database of one or more causes on a public web site; and
inviting public comment and feedback related to the one or more causes.

5. The method of claim 4, wherein the public comment and feedback includes a ranking of the importance and social impact of the one or more causes.

6. The method of claim 1 wherein the database of one or more causes includes a separate content file associated with each of the one or more causes, each of the content files containing information describing and promoting the associated cause.

7. The method of claim 1 wherein a portion of each disbursement of the payment is withheld by the host to compensate the host.

8. The method of claim 7 wherein the withheld portion of each disbursement of the payment reimburses the host for its costs and expenses.

9. The method of claim 1 wherein the host is a nonprofit corporation.

10. The method of claim 1 wherein the host is a for-profit corporation.

11. A system for receiving and utilizing online payments, comprising:
a server hosting an interactive website, the server configured to receive a payment designated for one or more selected causes, to forward the payment to a host, the host holding the payment in an account associated with the selected cause, the host disbursing a portion or all of the payment as directed by an entity associated with the selected cause, and wherein a portion of or all of the payment being disbursed to compensate providers for goods and services procured by the entity associated with the selected cause for carrying out a mission of the cause;
storage for a database of selectable causes, the database including a separate content file associated with each of the selectable causes, each content file containing descriptive and promotional information related to the associated selectable cause; and
storage for a database of one or more entities, each entity associated with one or more of the selectable causes, each of the entities linked to its associated selectable cause and its associated content file.

12. The system of claim 11, further comprising storage for a database of providers of goods and services, the provider database accessible at least by the entities associated with a selected cause.

13. The system of claim 12 wherein the server is further configured to host a plurality of personal web pages on the public web site, each of the entities associated with a selected causes and each of the providers is assigned a personal web page.

14. The system of claim 11 wherein the host is a nonprofit corporation.

15. The system of claim 11 wherein the host is a for-profit corporation.

16. A computer readable medium having stored thereon one or more sequences of instructions for causing one or more processors to perform steps for implementing receiving and utilization online of payments, the steps comprising:
establishing a web site comprising a database of one or more causes that may be selected by a payer, and a database of one or more entities, each entity associated with one or more of the causes;
receiving a payment from a payer, the payer selecting one or more of the causes to receive the benefit of the payment;
forwarding the payment to a host, the host holding the payment in an account associated with the selected cause; and
the host disbursing a portion or all of the payment as directed by the entity associated with the selected cause;
wherein a portion of or all of the payment being disbursed to compensate providers for goods or services procured by the entity associated with the selected cause for carrying out a mission of the cause.

17. The computer readable medium of claim 16 further comprising the steps of:
posting the database of one or more causes on a public web site; and
inviting public comment and feedback related to the one or more causes.

18. The computer readable medium of claim 17 wherein the public comment and feedback includes a ranking of the importance and social impact of the one or more causes.

19. The computer readable medium of claim 16 further comprising the step of withholding a portion of each payment to compensate the host.

20. The computer readable medium of claim 16 further comprising the step of withholding a portion of each disbursement of the payment to compensate the host for administrative costs and expenses.
